(19) United States
(12) Patent Application Publication
(10) Pub. No.: US 2009/0089768 A1
(43) Pub. Date: Apr. 2, 2009

(54) Data management for dynamically compiled software

(76) Inventors: Feng Chen, Shanghai (CN); Rongzhen Yang, Shanghai (CN)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/991,233

(22) PCT Filed: Sep. 29, 2005
(86) PCT No.: PCT/CN2005/001619

§ 371 Date: Feb. 28, 2008

(51) Int. Cl. G06F 9/45

(52) U.S. Cl. 717/148

(57) ABSTRACT

Method, apparatus and system are described to perform a data management. In some embodiments, a software application is dynamically compiled, data of the dynamically compiled software application is stored in a first region of a memory and instructions of the dynamically compiled software application are stored in a second region of the memory.

### BACKGROUND

A conventional virtual machine (VM) comprises a just-in-time (JIT) compiler to compile a software application (e.g., JAVA application) into codes that a processor of a computing device can identify and execute. Data and instructions of the JIT compiled codes are stored in an interleaved manner in a heap of the virtual machine that is utilizable by both an instruction cache and a data cache of the processor.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates an embodiment of a computing system including a virtual machine;

FIG. 2 illustrates an embodiment of the virtual machine;

FIG. 3 illustrates an embodiment of a data storing process;

FIG. 4 illustrates an embodiment of a data releasing process;

FIG. 5 illustrates an embodiment of a data description field used in FIGS. 3 and 4;

FIG. 6 illustrates an embodiment of data management in the virtual machine.

### DETAILED DESCRIPTION OF THE PREFERRED EMBODIMENTS

The following description describes techniques for data management in dynamically compiled software. In the following description, numerous specific details such as logic implementations, pseudo-code, means to specify operands, resource partitioning/sharing/duplication implementations, types and interrelationships of system components, and logic partitioning/integration choices are set forth in order to provide a more thorough understanding of the current invention. However, the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, that may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.) and others.

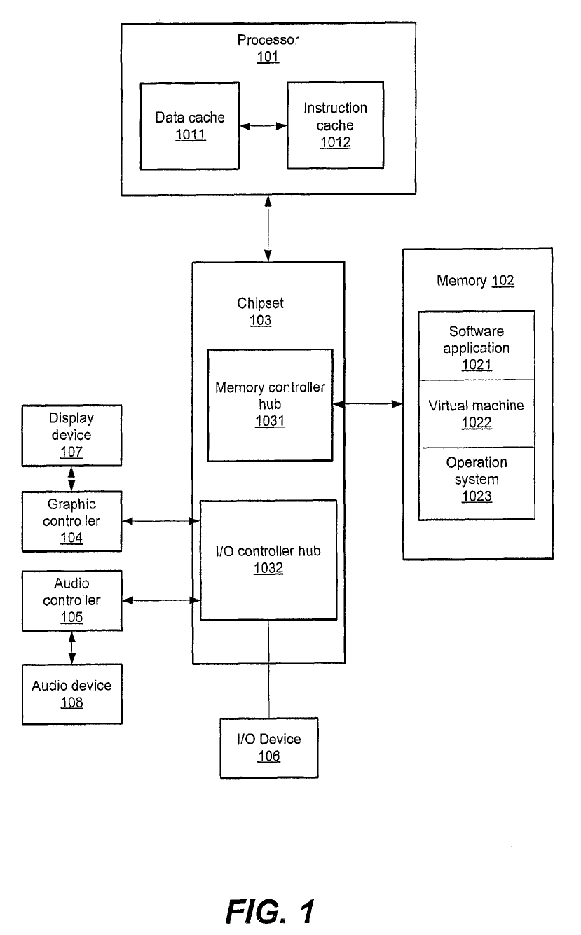

FIG. 1 shows an embodiment of a computing system 10 applying a novel data management method. A non-exhausive list of examples for the computing system 10 may include a personal computer, a workstation, a server computer, a personal digital assistant (PDA), a mobile telephone, a game console and the like.

The computing system 10 may comprise a processor 101, memory 102, chipset 103, a graphics controller 104, an audio controller 105, I/O devices 106, a display device 107, an audio device 108, etc. The processor 101 may execute codes under any suitable architecture, for example, Intel® Xscale architecture available from Intel Corporation of Santa Clara, Calif., and ARM architecture available from ARM Ltd., Cambridge, England. In an embodiment, the processor 101 may comprise a data cache 1011 and an instruction cache 1012. In another embodiment, the processor 101 may further comprise a data translation lookaside buffer (D-TLB) (not shown in FIG. 1) and an instruction translation lookaside buffer (I-TLB) (not shown in FIG. 1).

The memory 102 may store instructions and data as a software application 1021, a virtual machine 1022 and an operation system 1023. A non-exhausive list of examples for the memory 102 may comprise one or any combination of the following semiconductor devices, such as synchronous dynamic random access memory (SDRAM) devices, RAMBUS dynamic random access memory (RDRAM) devices, double data rate (DDR) memory devices, static random access memory (SRAM), flash memory devices, and the like.

The software application 1021 may be input from any suitable devices, such as the I/O device 106, the display device 107, the audio device, or the like. In other embodiments, the software application may also be generated by the computing system 10. Examples for the software application 1021 may comprise JAVA application (e.g., JAVA bytecode.class files), or .NET application (e.g., .NET codes), or the like. The virtual machine 1022 may execute between the software application 1021 and the operation system 1023. The operation system 1023 may include, but not limited to, different versions of Linux®, Microsoft® Windows®, and real time operating systems such as VxWorks®, etc.

The virtual machine 1022 may interpret a part of the software application 1021 under the processing architecture of the computing system 10, and may dynamically compile another part of the software application 1021 into machine codes identifiable and executable by the processor 101. Here, the dynamic compiling may be referred as just-in-time (JIT) compiling. A non-exhausive list of examples for the virtual machine 1022 may comprise a JAVA virtual machine available from Sun Microsystems Inc., Santa Clara, Calif., and NET virtual machine available from Microsoft® Corporate, Redmond, Washington.

The chipset 103 may comprise memory controller hub 1031 and I/O controller hub 1032. The memory controller hub 1031 may provide a communication link to a processor bus which may connect with the processor 101 and to any suitable device such as the memory 102. The memory controller hub 1031 may couple with the I/O controller hub 1032, which may provide an interface to I/O devices 106 or peripheral components for computing system 10 such as a keyboard and a mouse. A non-exhaustive list of examples for the I/O devices 106 may comprise a network card, a storage device, a camera, a blue-tooth, an antenna, and the like. The I/O controller hub 1032 may further provide a communication link to the graphics controller 104 and the audio controller 105. The graphics controller 104 may control the display of information on a display device 107.

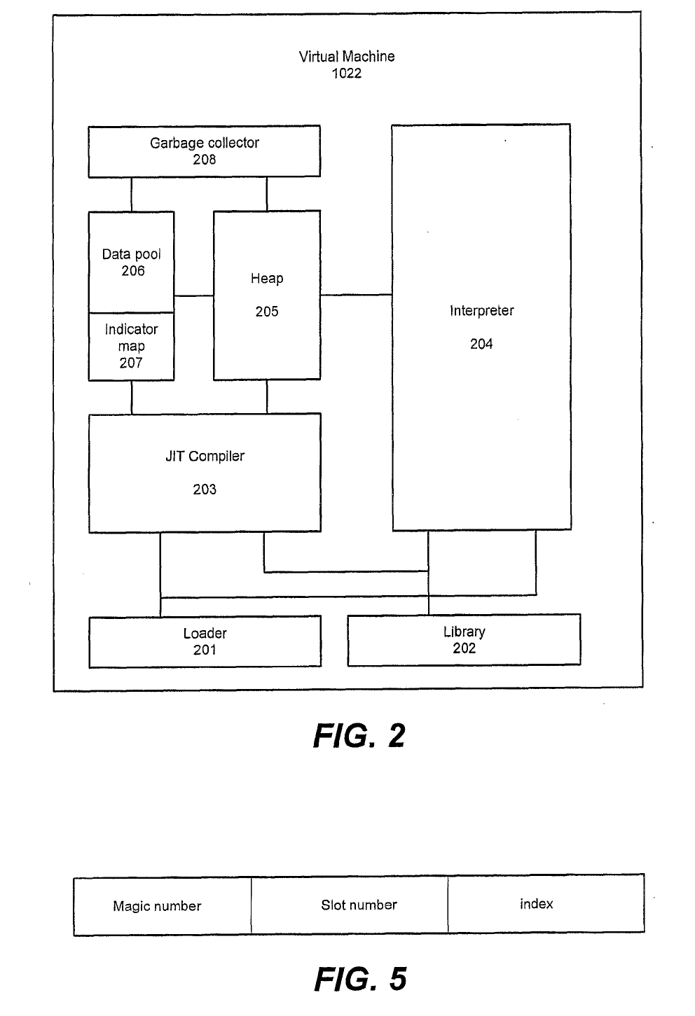

FIG. 2 shows an embodiment of the virtual machine 1022 of FIG. 1. According to the embodiment, the virtual machine 1022 may comprise a loader 201, library 202, JIT compiler 203, interpreter 204, heap 205, data pool 206, indicator map 207, and a garbage collector 208.

The loader 201 may load the software application 1021 in FIG. 1. In an embodiment that the software application 1021 is a JAVA application, the loader 201 may comprise a class file loader to load class file of the JAVA application. The library 202 may comprise various intrinsic functions or routines written in other language than the software application. The software application invoking the functions/routines from the library 202 may result in the codes that may be executable in the virtual machine 1022.

In an embodiment, the JIT compiler 203 may JIT compile a part of the software application 1021 (for example, JAVA methods of JAVA application) into machine codes identifiable and executable by the processor 101 of the computing system 10. In an embodiment that the processor 101 runs under Intel® Xscale or ARM processing architecture, the JIT compiled codes may comply with the Intel® Xscale or ARM code standard.

The interpreter 204 may decode and execute another part of the software application 1021, for example, some JAVA bytecodes of a JAVA application. The interpreted software could be executed by the processor 101 through interpreter's code path directly. According to an embodiment, the interpreter 204 may be written or tested to be compatible with the Intel® Xscale or ARM architecture.

The heap 205 may store instructions of a JIT compiled software application (e.g., a JIT compiled JAVA method) from the JIT compiler 203 that are utilizable by the instruction cache 1012 under instructions from the processor 101. The heap 205 may further store the software application before being compiled and/or interpreted by the JIT compiler 203 and/or the interpreter 204, as well as instructions and data from other part of the virtual machine than the JIT compiler 203 and the interpreter 204. In an embodiment that the computing system 10 runs under Intel® Xscale or ARM processing architecture, the heap 205 may store the instruction and data with 32 bit values.

The data pool 206 may store data of the JIT compiled software application output from the JIT compiler 203 (e.g., the JIT compiled JAVA method) that are utilizable by the data cache 1011 under instructions from the processor 101, but not by the instruction cache 1012. The data pool 206 may comprise a plurality of slots with a predetermined length. In an embodiment that the computing system 10 runs in compliance with Intel® Xscale or ARM architecture, each slot is 32 bits long. An example for the data may comprise immediate data complying with ARM architecture. An example for the data pool 206 may comprise a global constant pool that may be globally accessible.

The indicator map 207 may comprise a plurality of indicators to indicate usage state of the data pool. In an embodiment that the data pool 206 having a plurality of slots, each of the slots may have an indicator in the indicator map 207 associated therewith. Index of each slot in the data pool 206 may match with index of its indicator in the indicator map. Here, ‘index’ may represent the relative locations of the slots in the data pool 206. However, location of the slot may be represented in other ways, for example, the absolute memory address. In an embodiment, the indicator may comprise one bit to indicate the usage state ‘occupied’ and ‘blank’ of the slot. In another embodiment, the indicator map 207 may be located inside of the data pool 206, or separate from the data pool 206.

Modifications and variations to the above are possible. In an embodiment, indicator for each slot may be incorporated with the slot and the indicator map 207 may be omitted. According to such an embodiment, each slot of the data pool may comprise a bit used as the indicator.

In response to storing the data of the JIT compiled software application in the data pool 206, the JIT compiler 203 may generate a load instruction based upon the location of the data in the data pool 206 and store the load instruction as an instruction of the JIT compiled software application in the heap 205. The JIT compiler 203 may further generate a data description field based upon the location of the data in the data pool 206 and store the data description field in the heap 205.

The garbage collector 208 may release the JIT compiled software application. In an embodiment, the garbage collector 208 may release the JIT compiled software application that may not be frequently used or not used anymore. The garbage collector 208 may access the heap 205 to release the instructions of the JIT compiled software application, and access the indicator map 207 to change the usage state of the indicator associated with the slot that stores the data with reference to the data description field in the heap. The garbage collector 208 may further release the data description field from the heap 205.

Other embodiments may implement other modifications and variations to the structure and functionality of the virtual machine 1022. In an embodiment, the garbage collect 208 may release instructions and data other than those of the JIT compiled software application in the heap 205. In another embodiment, arrowed lines between components of the virtual machine 1022 as depicted in FIG. 2 may represent connection or coupling between the components.

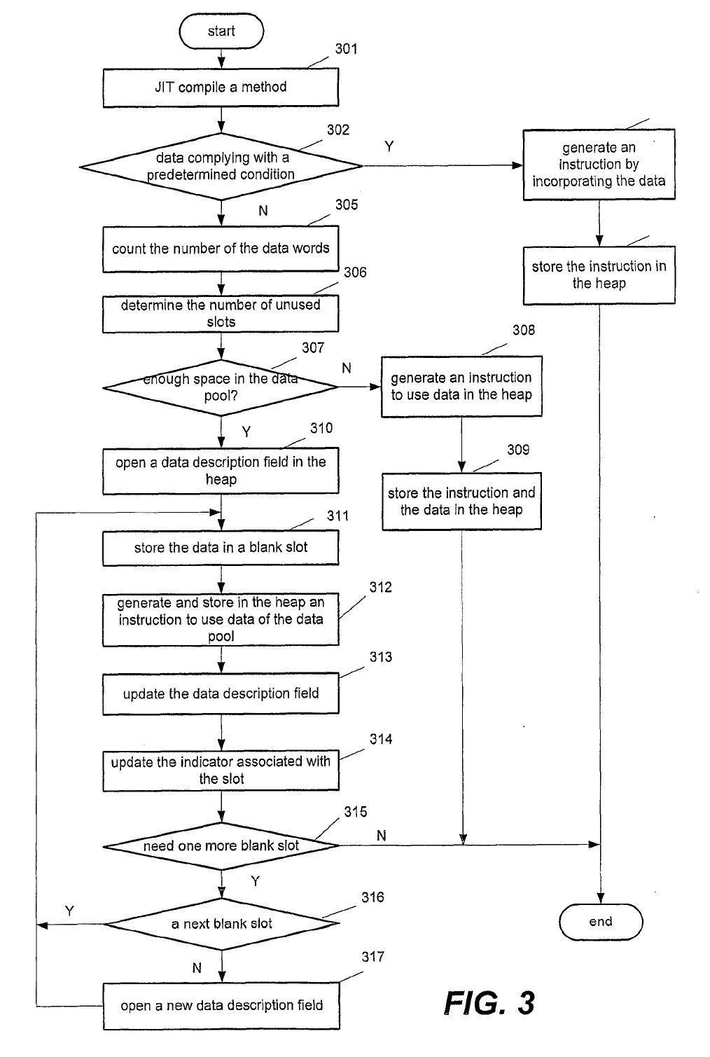

An embodiment of data storing process in the virtual machine 1022 is shown in FIG. 3. As shown, in block 301, the JIT compiler 203 may compile a software method. During the compiling, the JIT compiler 203 may determine whether the software method comprises a data in compliance with a predetermined condition, such as data complexity and data value in block 302. For example, under Intel® Xscale or ARM architecture, the predetermined condition may comprise the data value which could be represented as a result of rotating an eight-bit data by even bits ranging from 2-30. Then, the JIT compiler 203 may generate an instruction by incorporating the data in response to determining that the data may comply with the predetermined condition (block 303) and store the instruction in the heap 205 (block 304). An example of the instruction may comprise an arithmetic instruction, such as ‘MOV rₐ, 0×00ff’, wherein rₐ represents a register in the processor 101 of the computing system 10, 0×00ff represents the data.

However, if the data does not comply with the predetermined condition, then the JIT compiler 203 may determine the length of the data, for example, the number of the data words in block 305. In block 306, the JIT compiler 203 may scan the indicator map 207 and determine the number of slots that are not in use (e.g., blank slots). In block 307, the JIT compiler 203 may determine whether there is enough space in the data pool 206 to store the data. In an embodiment that each slot in the data pool 206 has a length of one word, the JIT compiler 203 may determine whether the number of blank slots is equal to or larger than the number of the data words to be stored. In other embodiments, the JIT compiler 203 may make the determination in other ways if the slot is of different length.

In response to determining that there is not enough space in the data pool 206 to store the data, the JIT compiler 203 may generate an instruction for the data (block 308) and store the instruction and data with an interleave manner in the heap 205 (block 309). Examples for the instruction may comprise a memory instruction such as a load instruction. For example, the JIT compiler 203 may generate the load instruction ‘load rₐ, [r_{pc}, 0×240]’, wherein rₐ represents a register in the processor 101 to load the data, r_{pc} represents another register in the processor 101 to store a memory address for the load instruction, 0×240 is an offset between the memory addresses of the data and the load instruction.

If, in block 307, the JIT compiler 203 determines that there is enough space in the data pool 206 to store the data, then the JIT compiler 203 may open a data description field in the heap 205 (block 310). The data description field may record information related to the data, such as memory location, length. However, the data description field may be stored in other places, such as a data pool 206.

Then, in block 311, the JIT compiler 203 may store the data in the data pool 206. For example, the data may be stored in a blank slot of the data pool 206 with index 1. In block 312, the JIT compiler 203 may generate an instruction for the data and store the instruction in the heap 205. Examples for the instruction may comprise a memory instruction such as a load instruction. In an embodiment, the JIT compiler 203 may generate the load instruction based upon the memory location of the data in the data pool 206, for example, ‘load rₐ, [DP PTR, offset 1′]’, wherein rₐ represents the register in the processor 101, DP PTR represents a pointer to the data pool 206, and offset 1′ represents an index of the slot storing the data, for example, index 1. Then, JIT compiler 203 may update the data description field in the heap 205 (block 313). FIG. 5 shows an embodiment for the data description field. As shown, the data description field may comprise a magic number to identify itself as a data description field, a slot number to represent the number of slots that store the data, and an offset number to indicate a memory offset for at least one of the slots. In an embodiment, the offset number may be represented by an index for the slot. For example, if the data is stored in the slot with index 1, the slot number and index of the data description field may be 1 for each.

Then, in block 314, the JIT compiler 203 may update an indicator associated with the slot storing the data in the indicator map 207. In an embodiment wherein the indicator comprises one bit to indicate ‘occupied’ (e.g. bit value ‘1’) and ‘blank’ (e.g. bit value ‘0’) states of the slot, the indicator may change the one bit from bit value ‘0’ to bit value ‘1’ to indicate that its associated slot (e.g., the slot with index 1) is occupied.

If there is a limitation to the length of the slot, e.g., the slot is one word long, then, in block 315 the JIT compiler 203 may determine whether one more slot in the data pool 205 is needed to store the data. If so, the JIT compiler 203 may further determine whether there is a blank slot in the data pool 205 next to the slot that has stored a part of the data in block 316. For example, if a first part of the data is stored in the slot with index 1, then the JIT compiler 203 may determine whether a slot with index 0 or slot with index 2 is blank to store a second part of the data.

In response to determining that there is a next blank slot, the JIT compiler 203 may return to blocks 311-315 to continue storing the data. However, there is an exemption for generating an instruction in block 312. For example, if the data is two words long, one slot is one word long and the JIT compiler 203 has generated a WLoad instruction for the first part of the data, then the JIT compiler 203 may not generate another load instruction for the second part of the data. This is because the WLoad instruction may load a data of two words in one action. When the JIT compiler 203 updates the data description field for the second part of the data in block 313, the slot number of the data description field may change from 1 to 2. It can be seen that the slot number of the data description field may represent the number of continuous slots that store the data, and the index number of the data description field may represent the index of the first slot.

However, if in block 316, the JIT compiler 203 determines that no blank slot in the data pool 206 is next to the slot that has stored the first part of the data, the compiler 203 may open a new data description field in the heap 205 in block 317. Then, the JIT compiler 203 may return to blocks 311-316 to continue storing the data.

Other embodiments may implement modifications and variations to the data storing process as shown in FIG. 3. For example, if the data description field comprises information for all of the slots that store the data no matter whether the slots are continuous with each other or not, then the blocks 316-317 may be omitted. For another example, the data description field may be encoded before being stored in the heap 205. For still another example, the data description field(s) may be opened in the heap 205 in one action after exploring blank slot(s) in the data pool 206.

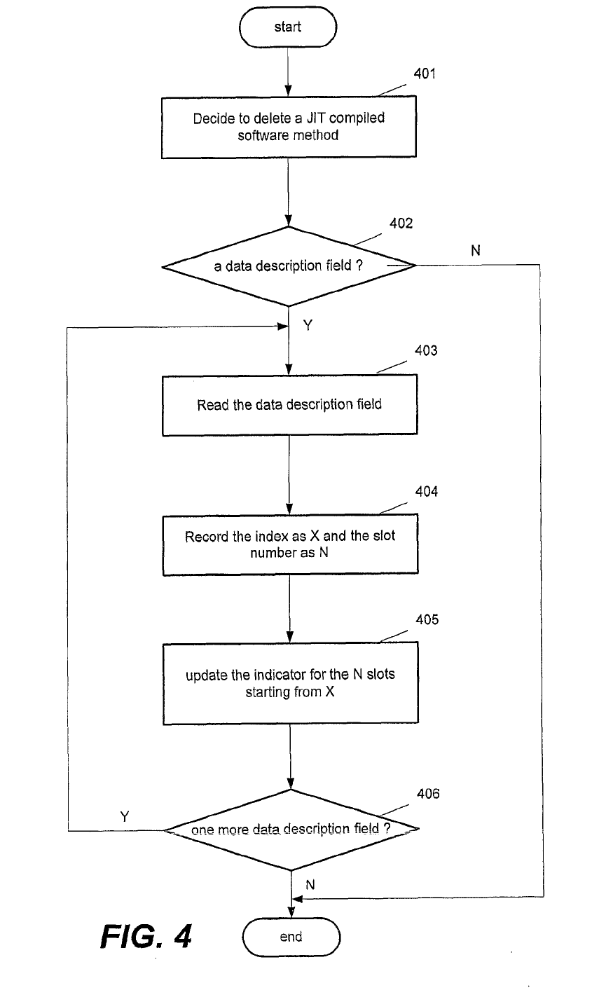

FIG. 4 shows an embodiment of data releasing process in the virtual machine. In block 401, the JIT compiler 203 or other suitable devices may decide to release a JIT compiled software application, for example, a compiled software method which may not be used frequently. Then, the garbage collector 208 may check whether the compiled software method has a data description field associated therewith in the heap 205 (block 402). The garbage collector 208 may read the data description field from the heap 205 (block 403), and record the index number as X and the slot number as N (block 404). Then, in block 405, the garbage collector 208 may release the data from the data pool 206 by updating the indicators for the N slots starting from index X, in order to indicate that the N slots are not in use. The garbage collect 208 may implement block 405 in various ways. For example, if each of the indicators comprises one bit to indicate ‘occupied’ (bit ‘1’) and ‘blank’ (bit ‘0’) states of the slot associated therewith, the indicators may be changed from bit ‘1’ to bit ‘0’ to indicate that their associated slots is blank.

Then, the garbage collector 208 may determine whether the JIT compiled software method contains one more data description field (block 406). If so, the garbage collector 208 may return to blocks 403-405 and continue the data releasing process. If not, the data releasing process for the JIT compiled software method A is completed.

Other embodiments may implement other modifications and variations to the data releasing process as shown in FIG. 4.

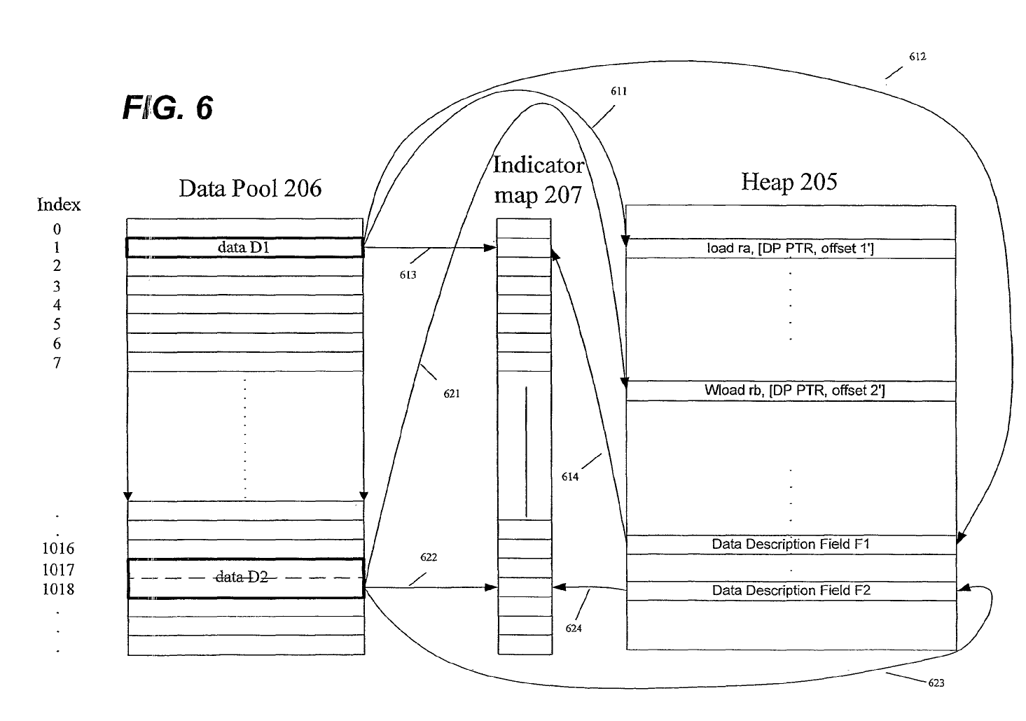

FIG. 6 shows an embodiment of data management for a virtual machine. In the data storing process, data D1 of the JIT compiled method A is stored in a slot of the data pool with slot index 1, and data D2 of the JIT compiled method A is stored in two continuous slots in the data pool with slot indics 1067 and 1068. A load instruction for data D1 is stored in the heap 205 (arrow 611), wherein the load instruction is generated based on the location of the slot with index 1 in the data pool 206. A WLoad instruction for data D2 is stored in the heap 205 (arrow 621), wherein the WLoad instruction is generated based on the location of the slot with index 1017 in the data pool 206. A data description field Fl for data D1 is updated to record information of the slot with index 1 (arrow 612). A data description field F2 for data D2 is updated to record information of the slots with indics 1017 and 1018 (arrow 622). Indicator for the slot with index 1 is mark as ‘occupied’ in the indicator map (arrow 613). Indicators for the slots with indics 1017 and 1018 are mark as ‘occupied’ in the indicator map (arrow 623). In the data releasing process, indicator for the slot with index 1 is marked as blank according to the information stored in the data description field F1 (arrow 614). Indicators for the slots with indics 1067 and 1068 are marked as blank according to the information stored in the data description field F2 (arrow 624).

Although the present invention has been described in conjunction with certain embodiments, it shall be understood that modifications and variations may be resorted to without departing from the spirit and scope of the invention as those skilled in the art readily understand. Such modifications and variations are considered to be within the scope of the invention and the appended claims.

What is claimed is:

1. A method, comprising:
dynamically compiling a software application;
storing data of the dynamically compiled software application in a first region of a memory; and
storing a plurality of instructions of the dynamically compiled software application in a second region of the memory.

2. The method of claim 1, wherein the first region is a memory region outside of a heap, and the second region is the heap

3. A method of claim 1, wherein the first region comprises a plurality of slots, each of the plurality of slots having an indicator associated therewith, the indicator indicating a usage state of the slot.

4. The method of claim 3, wherein storing the data further comprises:
storing the data in at least one of the plurality of slots; and
updating the at least one indicator associated with the at least one slot.

5. The method of claim 1, further comprising:
generating an instruction according to a location of the data in the first region; and
storing the generated instruction in the second region.

6. The method of claim 1, further comprising:
updating at least one data description field in the second region to store information related to a location of the data in the first region.

7. The method of claim 6, wherein the information related to the location of the data in the first region comprises an index for a slot in the first region that stores the data.

8. The method of claim 1, further comprising:
determining to release the data of the dynamically compiled software application from the first region;
reading from the second region a data description field that stores information related to a location of the data in the first region.
updating an indicator associated with a slot of the first region that stores the data based upon the information of the read data description field.

9. An apparatus, comprising:
a dynamic compiler to dynamically compile a software application; and
a data pool having a plurality of slots, each slot having an associated indicator to indicate a usage state of the slot, wherein at least one of the plurality of slots stores data of the dynamically compiled software application.

10. The apparatus of claim 9, further comprises a heap to store a plurality of instructions of the dynamically compiled software application.

11. The apparatus of claim 9, wherein the data pool further comprises:
a bit map comprising a plurality of bits, wherein each of the plurality of bits associates with each of the plurality of slots and indicates a usage state of the associated slot.

12. The apparatus of claim 9, wherein the dynamic compiler stores the data in at least one of the plurality of slots in the data pool; and updates the at least one indicator associated with the at least one slot.

13. The apparatus of claim 9, wherein the dynamic compiler generates an instruction based upon a location of the data in the data pool and stores the generated instruction in a heap.

14. The apparatus of claim 9, wherein the dynamic compiler updates a data description field in a heap to store information related to a location of the data in the data pool.

15. The apparatus of claim 14, wherein the information related to the location of the data in the data pool comprises an index of the slot of the data pool that stores the data.

16. The apparatus of claim 9, further comprises a garbage collector to determine to release the data of the dynamically compiled software application from the data pool; read a data description field in a heap that stores information related to a location of the data in the data pool; and update an indicator associated with the slot of the data pool that stores the data based upon the information of the read data description field.

17. A machine-readable medium comprising a plurality of instructions, that in response to being executed, result in a computing system:
dynamically compiling a software application;
storing data of the dynamically compiled software application in a first region of a memory;
storing a plurality of instructions of the dynamically compiled software application in a second region of the memory.

18. The machine-readable medium of claim 17, wherein the first region comprises a plurality of slots, each of the plurality of slots having an indicator associated therewith, the indicator indicating a usage state of the slot.

19. The machine-readable of claim 18, wherein the plurality of instructions that result in the computing system storing the data, further result in the computing system:
storing the data in at least one of the plurality of slots; and
updating the at least one indicator associated with the at least one slot.

20. The machine-readable of claim 17, wherein the plurality of instructions further result in the computing system:
generating an instruction based upon a location of the data in the first region; and
storing the generated instruction in the second region.

21. The machine-readable of claim 17, wherein the plurality of instructions further result in the computing system:
updating at least one description field in the second region to store information related to a location of the data in the first region.

22. The machine-readable of claim 21, wherein the information related to the location of the data in the first region comprises an index for a slot of the first region that stores the data.

23. The machine-readable of claim 17, wherein the plurality of instructions further result in the computing system:
determining to release the data of the dynamically compiled software application from the first region;
reading from the second region a data description field that stores information related to a location of the data in the first region.
updating an indicator associated with a slot of the first region that stores the data based upon the information of the read data description field.

24. A system, comprising:
a processor comprising a data cache and an instruction cache; and
a memory comprising:
a first region utilizable by the data cache, to store data of a dynamically compiled software application; and
a second region utilizable by the instruction cache, to store a plurality of instructions of the dynamically compiled software application;
wherein, the first region is not utilizable by the instruction cache.

25. The system of claim 24, wherein the first region comprises a plurality of slots, each of the plurality of slots having an indicator associated therewith, the indicator indicating a usage state of the slot.

26. The system of claim 24, wherein the first region comprises:
a plurality of slots to store the data; and
a bit region to store a plurality of bits, wherein each of the plurality of bits associates with each of the plurality of slots and indicates a usage state of the associated slot.

27. The system of claim 24, wherein the data is stored in at least one of a plurality of slots in the first region; and at least one indicator associated with the at least one slot is updated, wherein the at least one indicator indicates a usage state of the at least one slot.

28. The system of claim 24, wherein the plurality of instructions of the dynamically compiled software application comprises an instruction generated based upon a location of the data in the first region.

29. The system of claim 24, wherein the second region further comprise a data description field to store information related to a location of the data in the first region.

30. The system of claim 24, further comprises codes in the memory determine to release the data of the dynamically compiled software application from the first region; read from the second region a data description field that stores information related to a location of the data in the first region; and update an indicator associated with a slot of the first region that stores the data based upon the information of the read data description field.
